(19) United States
(12) Patent Application Publication
(10) Pub. No.: US 2026/0147221 A1
(43) Pub. Date: May 28, 2026

(54) FAST-AXIS COLLIMATOR LENS FOR COLLIMATING BLUE-WAVELENGTH LIGHT SOURCES

(71) Applicant: MPNICS CO., LTD., Gwangju (KR)

(72) Inventors: SANG DO KANG, Gwangju (KR); SEUNG KEUN OH, Gwangju (KR); HYUN JONG KANG, Gwangju (KR)

(21) Appl. No.: 19/171,440

(22) Filed: Apr. 7, 2025

(30) Foreign Application Priority Data
Nov. 27, 2024 (KR) 10-2024-0172210

(51) Int. Cl. G02B 27/30; G02B 27/09

(52) U.S. Cl. CPC G02B 27/30; G02B 27/0955

(57) ABSTRACT

A fast-axis collimator lens for collimating a blue-wavelength light source can minimize beam loss by making a light divergence angle less than or equal to 0.4 mrad when collimating the blue-wavelength light source. A wavelength of the light source is between 400 nm and 500 nm and a light divergence angle of an emitting plane is less than or equal to 0.4 mrad.

### CROSS-REFERENCE TO RELATED APPLICATION AND CLAIM OF PRIORITY

This application claims the benefit under 35 USC § 119 of Korean Patent Application No. 10-2024-0172210, filed on Nov. 27, 2024, in the Korean Intellectual Property Office, the entire disclosure of which is incorporated herein by reference for all purposes.

### BACKGROUND

### 1. Technical Field

The present disclosure relates to a fast-axis collimator lens and, more specifically, to a fast-axis collimator lens for collimating a blue-wavelength light source, which can minimize beam loss by making a light divergence angle less than or equal to 0.4 mrad when collimating the blue-wavelength light source.

### 2. Description of the Related Art

A fast-axis collimator lens (FAC) is used to collimate light emitted from high-power lasers such as laser diodes (LD) into parallel light, and is used in various industrial fields, including optical communications, industrial manufacturing such as laser cutting, and medical equipment.

The need for the fast-axis collimator lens has increased in high-quality video conferencing systems, and has accelerated growth due to the shift to online communication and remote work during the COVID-19 pandemic.

The demand for copper is increasing owing to the increase in production of electric vehicles and the progress in electrification and automation across industries. Copper exhibits strong absorption properties in blue-wavelength light, so it is advantageous to use a blue-wavelength laser for processing rather than lasers with other wavelengths. Thereby, the demand for blue-wavelength lasers is rapidly increasing.

Conventional fast-axis collimator lenses have a problem in that beam loss is large because of large divergence angles when collimating light in a high-power blue-wavelength range (400 nm to 500 nm).

More specifically, the distance where the fast-axis collimator lens collimates light in a conventional blue-wavelength laser module ranges from about 80 mm to 200 mm, and as the collimating distance increases, the beam loss occurs due to divergence, thereby resulting in a decrease in output.

Therefore, it is necessary to develop a fast-axis collimator lens for minimizing beam loss due to beam divergence in order for a blue-wavelength laser module to achieve high performance.

### SUMMARY

The present disclosure is devised to solve the problems described above, and an objective of the present disclosure is to provide a fast-axis collimator lens for minimizing loss due to beam divergence by collimating light in a blue-wavelength range into a divergence angle of 0.4 mrad or less.

In order to achieve the objective, the present disclosure provides a fast-axis collimator lens for collimating and outputting an input light source, wherein a wavelength of the light source is between 400 nm and 500 nm and a light divergence angle of an emitting plane is less than or equal to 0.4 mrad.

In a preferred exemplary embodiment, a numerical aperture of an incident plane of the fast-axis collimator lens is less than or equal to 0.8, a working distance, the distance between the light source and the incident plane, is 0.076±0.01 mm, a refractive index is between 1.75 and 1.82, and an effective focal length is between 0.375 mm and 0.384 mm.

In a preferred exemplary embodiment, a radius of curvature of an emitting plane of the fast-axis collimator lens is greater than or equal to 0.291 mm and less than or equal to 0.305 mm.

The present disclosure has the following excellent effects.

According to the fast-axis collimator lens of the present disclosure, it has an advantage of collimating a blue-wavelength laser having a wavelength of 400 nm to 500 nm while minimizing beam loss by making the divergence angle less than or equal to 0.4 mrad.

### BRIEF DESCRIPTION OF THE DRAWINGS

FIG. 1 is a view for illustrating a fast-axis collimator lens according to an exemplary embodiment of the present disclosure,

FIG. 2 is a view for showing a design specification of a fast-axis collimator lens according to an exemplary embodiment of the present disclosure,

FIG. 3 is a graph for showing a relationship between an incident light wavelength and a light divergence angle of a fast-axis collimator lens according to an exemplary embodiment of the present disclosure, and

FIG. 4 is a graph for showing a relationship between a refractive index and a light divergence angle of a fast-axis collimator lens according to an exemplary embodiment of the present disclosure.

### DETAILED DESCRIPTION OF THE DISCLOSURE

The terms used in the present disclosure have been selected from commonly used terms as much as possible, but in certain cases, there are terms arbitrarily selected by the applicant, in which case a meaning should be understood in consideration of the meaning described or used in the detailed description of the present disclosure, rather than the simple name of the term.

Hereinafter, the technical configuration of the present disclosure will be described in detail with reference to the preferred exemplary embodiments illustrated in the accompanying drawings.

However, the present disclosure is not limited to the exemplary embodiments described herein and may be embodied in other forms. Throughout the specification, the same reference numerals refer to the same components.

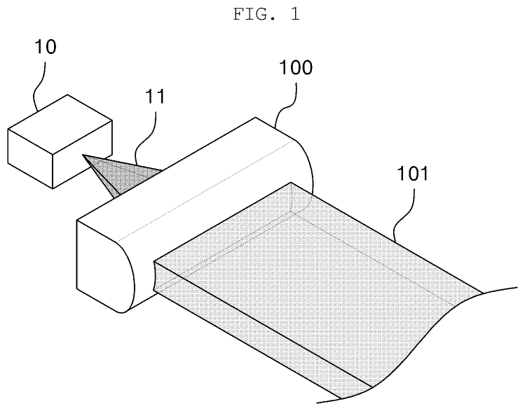

FIG. 1 is a view for illustrating a fast-axis collimator lens according to an exemplary embodiment of the present disclosure.

Referring to FIG. 1, the fast-axis collimator lens 100 according to an exemplary embodiment of the present disclosure may collimate a light source 11 input from a light source 10, which is a laser diode, and may output the same as parallel light 101.

In addition, the fast-axis collimator lens 100 can be utilized in various fields, such as the optical communication field, the laser cutting field, the medical image processing field, and the like and, in particular, be utilized in any field as long as for collimating a light source in the blue-wavelength range of 400 nm to 500 nm by using the light source 10.

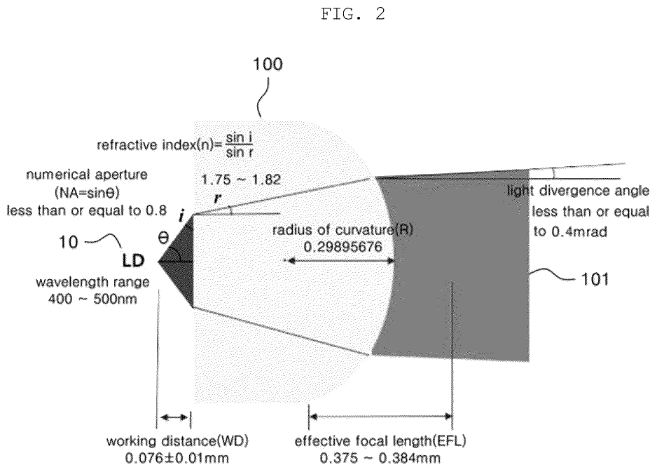

FIG. 2 is a view for showing a design specification of a fast-axis collimator lens according to an exemplary embodiment of the present disclosure.

Referring to FIG. 2, the fast-axis collimator lens 100 may have a shape with a light incident plane flat and with a light emitting plane a convex curved surface and an elongated rod shape.

In addition, the light divergence angle of the light emitting plane may be less than or equal to 0.4 mrad. In addition, the light divergence angle may be an angle indicating how much light is emitted upward and downward from the plane.

In addition, the numerical aperture (NA) of the incident plane of the fast-axis collimator lens 100 may be less than or equal to 0.8, a working distance (WD), the distance between the light source and the incident plane, may be 0.076±0.01 mm, a refractive index (n) may be between 1.75 and 1.82, and an effective focal length (EFL) may be between 0.375 mm and 0.384 mm.

In addition, a radius of curvature of the emitting plane of the fast-axis collimator lens 100 may be greater than or equal to 0.291 mm and less than or equal to 0.305 mm.

When designed in this way, the blue-wavelength laser can be collimated into the light divergence angle of 0.4 mrad or less.

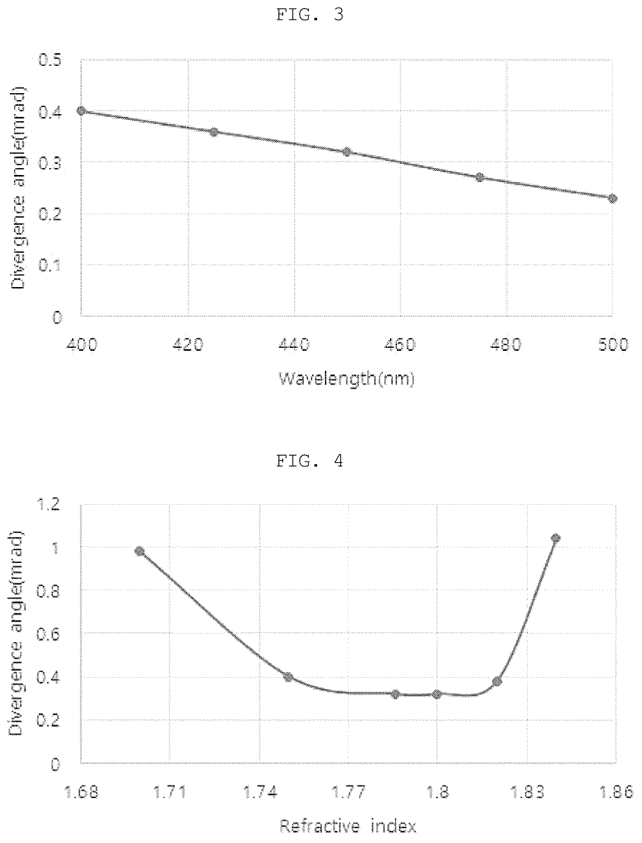

FIG. 3 is a graph for showing a relationship between an incident light wavelength and a light divergence angle of a fast-axis collimator lens according to an exemplary embodiment of the present disclosure and, referring to FIG. 3, it can be seen that the fast-axis collimator lens 100 designed according to the present disclosure has the light divergence angle of 0.4 mrad or less in the blue-wavelength range (400 nm to 500 nm), and the light divergence angle according to the used wavelength is as shown in Table 1 below.

TABLE 1

| Working | Effective | Used | Light |
|---|---|---|---|
| Distance | Focal Length | Wavelength | Divergence |
| (WD; mm) | (EFL; mm) | (WL, nm) | Angle (mrad) |
| 0.073 | 0.375 | 400 | 0.400 |
| 0.075 | 0.378 | 425 | 0.360 |
| 0.076 | 0.380 | 450 | 0.320 |
| 0.077 | 0.383 | 475 | 0.270 |
| 0.078 | 0.384 | 500 | 0.230 |

That is, in order to satisfy the performance where the light divergence angle is about 0.4 mrad when the wavelength is 400 nm in the fast-axis collimator lens designed according to the present disclosure, the used wavelength should be 400 nm≤WL≤500 nm and, under the corresponding conditions, the effective focal length should satisfy 0.375 mm≤EFL≤0.384 mm.

In addition, FIG. 4 is a graph for showing a relationship between a refractive index and a light divergence angle of a fast-axis collimator lens according to an exemplary embodiment of the present disclosure.

Referring to FIG. 4, it can be seen that the fast-axis collimator lens 100 designed according to the present disclosure should have a refractive index of 1.75≤n≤1.82 in order to satisfy the performance where the light divergence angle is less than or equal to 0.4 mrad in the blue-wavelength range (400 nm to 500 nm).

In addition, the beam divergence angle according to the refractive index is as shown in Table 2 below.

TABLE 2

| Effective | Refractive | Light | Radius of |
|---|---|---|---|
| Focal Length | Index | Divergence | Curvature of |
| (EFL; mm) | (n) | Angle (mrad) | Lens (R, mm) |
| 0.401 | 1.7000 | 0.979 | 0.281 |
| 0.388 | 1.7500 | 0.400 | 0.291 |
| 0.380 | 1.7858 | 0.320 | 0.299 |
| 0.377 | 1.8000 | 0.320 | 0.301 |
| 0.372 | 1.8200 | 0.379 | 0.305 |
| 0.368 | 1.8400 | 1.039 | 0.309 |

That is, it can be seen that the fast-axis collimator lens designed according to the present disclosure should enable the range of the effective focal length to satisfy 0.372 nm≤EFL≤0.388 nm and the range of curvature radius of the lens to satisfy 0.291 mm≤R≤0.305 mm in the condition for allowing the refractive index to satisfy 1.75≤n≤1.82.

The present disclosure has been illustrated and described with reference to the preferred exemplary embodiments as described above, but the present disclosure is not limited to the exemplary embodiments described above, and various changes and modifications may be made by those skilled in the art to which the present disclosure belongs within the scope not departing from the spirit of the present disclosure.

What is claimed is:

1. A fast-axis collimator lens for collimating and outputting an input light source,
wherein a wavelength of the light source is between 400 nm and 500 nm and a light divergence angle of an emitting plane is less than or equal to 0.4 mrad.

2. The lens of claim 1, wherein a numerical aperture of an incident plane of the fast-axis collimator lens is less than or equal to 0.8,
a working distance, the distance between the light source and the incident plane, is 0.076±0.01 mm,
a refractive index is between 1.75 and 1.82, and
an effective focal length is between 0.375 mm and 0.384 mm.

3. The lens of claim 2, wherein an radius of curvature of the emitting plane of the fast-axis collimator lens is greater than or equal to 0.291 mm and less than or equal to 0.305 mm.
